(19) United States
(12) Patent Application Publication
(10) Pub. No.: US 2020/0070803 A1
(43) Pub. Date: Mar. 5, 2020

(54) BRAKING SYSTEM FOR A VEHICLE

(71) Applicant: Continental Automotive Systems, Inc., Auburn Hills, MI (US)

(72) Inventors: Eric Alan MATOY, Auburn Hills, MI (US); Justin Audley RUEDIGER, Auburn Hills, MI (US); Christopher Allen HARRISON, Auburn Hills, MI (US)

(73) Assignee: Continental Automotive Systems, Inc., Auburn Hills, MI (US)

(21) Appl. No.: 16/493,171

(22) PCT Filed: Mar. 6, 2017
(86) PCT No.: PCT/US2017/020906

§ 371 Date: Sep. 11, 2019

Related U.S. Application Data
(60) Provisional application No. 62/303,726, filed on Mar. 4, 2016.

(51) Int. Cl. B60W 10/192; B60T 7/04; B60W 10/188; B60T 8/36

(52) U.S. Cl. CPC B60W 10/192; B60T 8/365; B60W 10/188; B60T 7/042

(57) ABSTRACT

A braking control module includes a housing with at least one fluid line disposed within the housing. First and second inlet ports are each in communication with the fluid line or electronic input. Additionally, a linear actuator is in fluidic communication with the fluid line for controlling pressure in the at least one fluid line. A processor controls operation of the linear actuator. The braking control module further includes at least one outlet port in fluidic communication with the fluid line and connectable to a brake. The braking system also includes a tandem, single or electronic master cylinder having a first bore defining a first volume and an optional second bore defining a second volume. First and second pistons are connectable to a brake pedal and in connection with the first inlet port and the second inlet port, respectively, or in electronic communication with the EBS unit.

### CROSS REFERENCE TO RELATED APPLICATIONS

This application claims the benefit of PCT Application PCT/US2017/020906, filed Mar. 6, 2017, which claims the benefit of U.S. provisional patent application No. 62/303,726 filed Mar. 4, 2016 which is hereby incorporated by reference.

### TECHNICAL FIELD

The technical field relates to braking systems and methods of operating braking system.

### BACKGROUND

Braking systems for a motor vehicle generally include a hydraulic circuit that actuates wheel cylinders to impart braking torque. Conventional braking systems are actuated responsive to action by a vehicle operator. Advanced vehicle systems integrate control, pumps and motors for operating the brake system into a single assembly and/or housing.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In one exemplary embodiment, a braking system for a vehicle includes a braking control module. The braking control module includes a housing with at least one fluid line disposed within the housing. A first inlet port is in fluidic or electronic communication with the at least one fluid line or electronic port. A optional second inlet port is in fluidic communication with the at least one fluid line. The braking control module further includes a linear actuator in fluidic communication with the at least one fluid line for controlling pressure in the at least one fluid line. A processor is in communication with the linear actuator for controlling operation of the linear actuator. The braking control module further includes at least one outlet port in fluidic communication with the at least one fluid line and connectable to a brake. The braking system also includes a single, tandem or electronic master cylinder. The single master cylinder includes a first bore defining a first volume and the tandem master cylinder includes a first bore defining a first volume and a second bore defining a second volume. A first piston is operatively connectable to a brake pedal and in fluidic connection with the first inlet port. A second piston is operatively connectable to the brake pedal and in fluidic connection with the second inlet port. The electronic master cylinder is in electrical communication with the braking module and can be connected to a brake pedal.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block schematic diagram of a braking system for a vehicle having a tandem master cylinder with equal volumes according to one exemplary embodiment;

FIG. 2 is a block schematic diagram of the braking system having the tandem master cylinder with unequal volumes according to one exemplary embodiment;

FIG. 3 is a block schematic diagram of a braking system having an electronic braking system (“EBS”) unit disposed outside a braking control module according to one exemplary embodiment; and

FIG. 4 is a block schematic diagram of the braking system including the EBS unit disposed between the master cylinder and the braking control module according to one exemplary embodiment.

### DETAILED DESCRIPTION

Referring to the Figures, wherein like numerals indicate like parts throughout the several views, a braking system 10 for a vehicle 12 is shown and described herein.

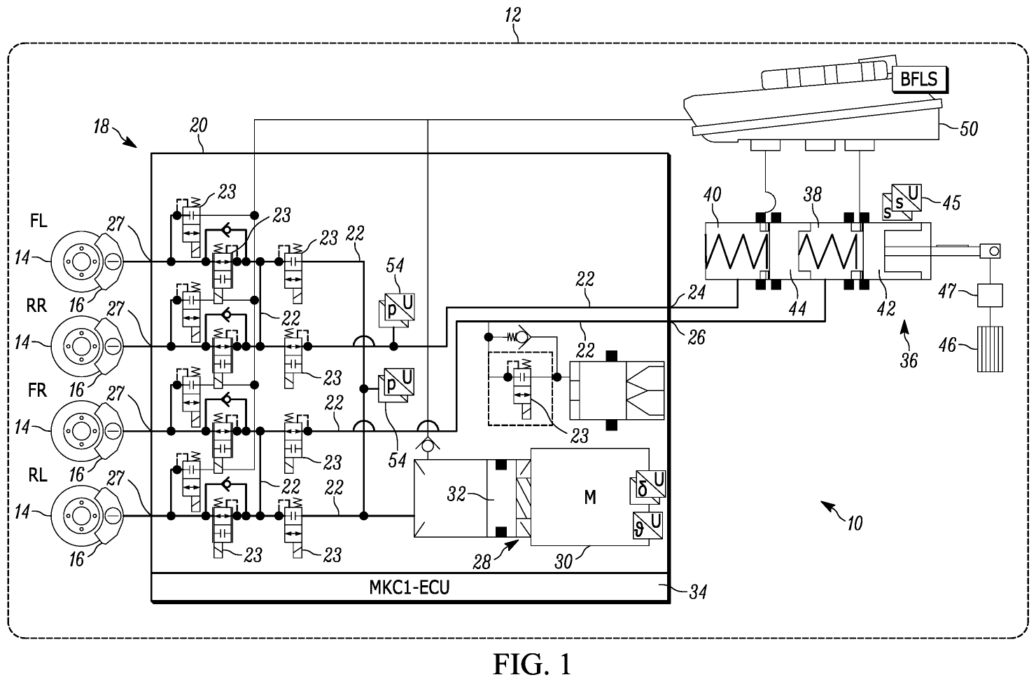

In the exemplary embodiments shown in FIGS. 1-4, the vehicle 12 includes four wheels 14. A brake 16 is engagable with at least a portion of each wheel 14 to slow and/or stop the vehicle 12 as is readily appreciated by those skilled in the art. Each brake 16 includes a hydraulic connection (not numbered) for receiving a hydraulic fluid for controlling operation of the brake 16.

The braking system 10 includes a braking control module 18. The braking control module 18 includes a housing 20 for enclosing and otherwise supporting the various components (described below) of the braking control module 18. In the exemplary embodiment, the housing 20 is formed primarily of a metal. However, it should be appreciated that other materials may be utilized to form the housing 20.

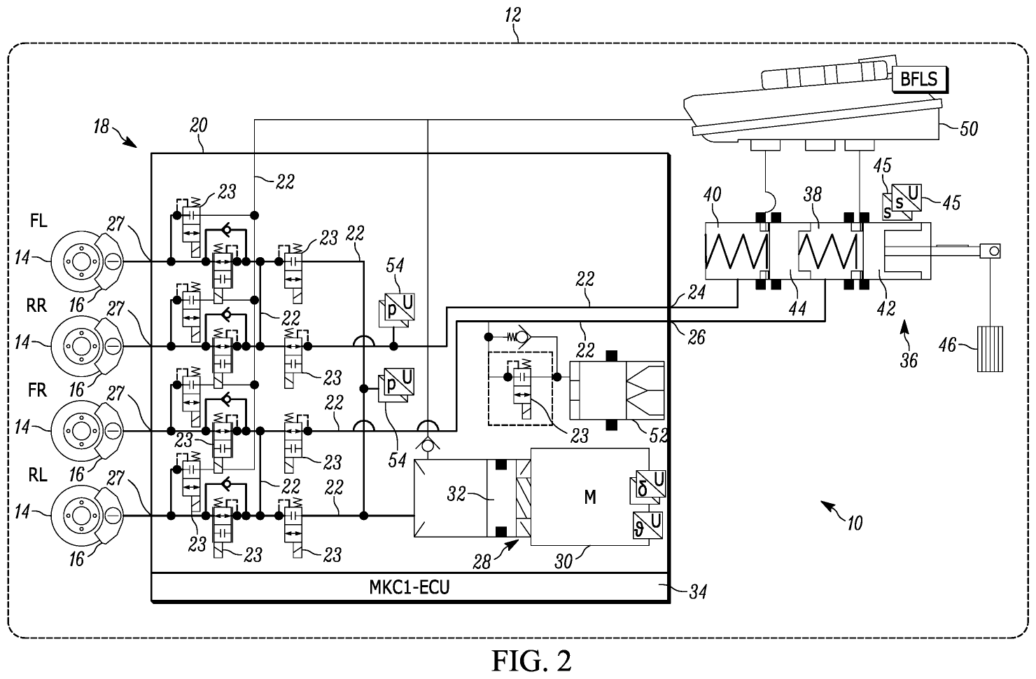

At least one fluid line 22 is disposed within the housing 20. The at least one fluid line 22 conveys hydraulic fluid therein. In the exemplary embodiments, shown in FIGS. 1 and 2, the at least one fluid line 22 may be implemented as a plurality of fluid lines 22. As appreciated by those skilled in the art, numerous techniques to form and/or otherwise implement the fluid lines 22 may be utilized.

The braking control module 18 of the exemplary embodiments includes a plurality of valves 23. The valves 23 are in fluidic connection to the fluid lines 22 to selectively connect fluid lines 22 together and disconnect fluid lines 22 from one another. In the exemplary embodiments, the valves 23 are each electrically controlled, i.e., operated via a solenoid (not numbered) or other such device. In the exemplary embodiments, thirteen valves 23 are utilized as shown in FIGS. 1 and 2.

The braking control module 18 also includes a first inlet port 24 and a second inlet port 26. The first and second inlet ports 24, 26 are in fluidic communication with the at least one fluid line 22. In the exemplary embodiments, the housing 20 forms the first and second inlet ports 24, 26 and provide access to the fluid lines 22.

The braking control module 18 further includes at least one outlet port 27. In the exemplary embodiment four outlet ports 27 are utilized. Each outlet port 27 is in fluidic communication with the at least one fluid line 22. Each outlet port 27 is also connectable to one of the brakes 16.

The braking control module 18 further includes an actuator 28 in fluidic communication with the at least one fluid line 2. The actuator 28 is configured to control pressure in the at least one fluid line 22. In the exemplary embodiment, the actuator 28 is a linear actuator (not separately numbered) having an electric motor 30 operatively connected to a piston 32. The electric motor 30 controls movement of the piston 32 to change pressure in the at least one fluid line 22. The motor 30 may include a redundant rotary position sensor (not numbered) for determining a displacement of the piston 32 in the actuator 28 and/or the speed of the motor 30.

The braking system 10 includes a processor 34. In the exemplary embodiment, the processor 34 is an electronic device capable of performing mathematical calculations and/or executing instructions, i.e., running a program. The processor 34 may be implemented with a microprocessor, microcontroller, application specific integrated circuit (“ASIC”), and/or any other suitable device as appreciated by those skilled in the art. The processor 34 may include ancillary circuits (not shown) to interface with various devices as is also appreciated by those skilled in the art. In the exemplary embodiments, the processor 34 is disposed within the housing 20. However, it should be appreciated that the processor 34 may be located outside of the housing 20.

The processor 34 is in communication with the actuator 28 for controlling operation of the actuator 28. That is, the processor 34 sends a command and/or data to the actuator 28 and, in response, the actuator 28 moves the piston 32 in accordance with the command and/or data. The actuator 28 may include a processor (not shown) or other integrated circuit for receiving and/or sending data to and/or from the processor 34.

The processor 34 of the exemplary embodiment is also in communication with at least one of the plurality of valves 23. As such, the processor 34 may be utilized to control one or more of the valves 23. For example, the processor 34 may send a command and/or data to the valves 23 to open or close. Each valve 28 may include a processor (not shown) or other integrated circuit for receiving and/or sending data to and/or from the processor 34.

As shown in FIGS. 1, 2, and 4, the braking system 100 may also include a master cylinder 36. More particularly, the master cylinder 36 of the exemplary embodiments is a tandem master cylinder 36 defining a first bore 38 and a second bore 40. The tandem master cylinder 36 includes a first piston 42 disposed at least partially in the first bore 38 and a second piston 44 disposed at least partially in the second bore 44. A brake pedal 46 is operatively connectable to the first piston 42 and the second piston 44. As such, the brake pedal 46 may be utilized to induce motion in the pistons 42, 44 without necessarily having a direct connection thereto.

The braking system 100 may include at least one travel sensor 45. The at least one travel sensor 45 is configured to determine a distance travelled by at least one of the first piston 42 and the second piston 44. In the exemplary embodiments, the braking system 100 includes a pair of travel sensors 45 for measuring the distance travelled by both the first piston 42 and the second piston 44. The at least one travel sensor 45 may be in communication with the processor 34 such that the processor 34 obtains data regarding distance travelled by the pistons 42, 44.

In the exemplary embodiment, the first bore 38 is in fluidic communication with the second inlet port 26 while the second bore 40 is in fluidic communication with the first inlet port 24. Of course, in other embodiments, this arrangement may be reversed. By being in fluidic communication with the first and second inlet ports 24, 26, the first and second bores 38, 40 are then also in fluidic communication with fluid lines 22, as shown in the figures.

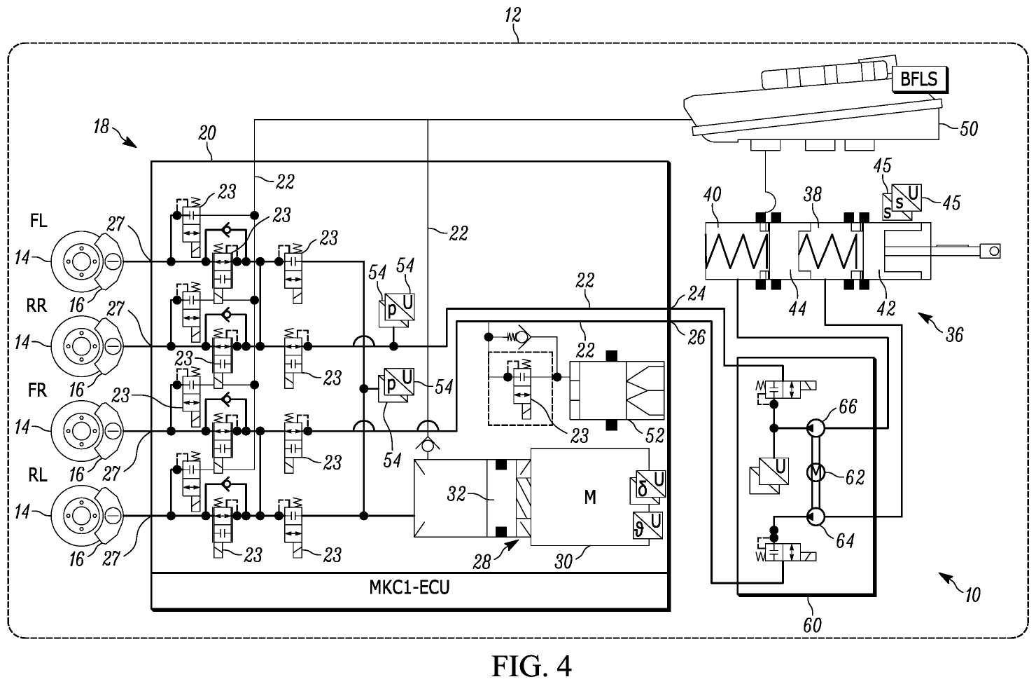

In the exemplary embodiments shown in FIGS. 1, 2, and 4, the first bore 38 defines a first volume and the second bore 40 defines a second volume. In FIGS. 1 and 4, the first volume is equal to the second volume. However, in FIG. 2, the first volume is different from the first volume. As such, in the embodiment shown in FIG. 2, each bore 38, 40 perform differently with respect to changing the fluidic pressure on the respective inlet port 26, 24 and, accordingly, the respective fluid line 22. Thus, when a driver of the vehicle 12 actuates the brake pedal 46, the tandem master cylinder 36 may produce differing changes in pressure on different fluid lines 22.

The braking system 10 in the embodiment shown in FIG. 1 includes a variable ratio mechanism 47 operatively connected to the pedal 46 and the tandem master cylinder 36. The variable ratio mechanism 47 is configured to provide a variable pedal ratio between the brake pedal 46 and the tandem master cylinder 36. As such, the brake pedal 46 may be utilized to provide differing changes in pressure on the fluid lines 22.

The braking system 10 may also include a fluid reservoir 50 for storing hydraulic fluid. In the exemplary embodiments, the fluid reservoir 50 is disposed outside of the housing 20. In FIGS. 1, 2, and 4, the fluid reservoir 50 is in fluidic communication with the first bore 38 and the second bore 40 of the tandem master cylinder 36 to supply hydraulic fluid to the tandem master cylinder 36 as needed. The fluid reservoir 50 of the exemplary embodiment is also in fluidic communication with one or more of the fluid lines 22 and/or the valves 23, as shown in the figures.

The braking control module 18 may also includes a pedal force simulator 52. The pedal force simulator 52 in the exemplary embodiment is disposed within the housing 20 and in fluidic communication with the at least one fluid line 22. The pedal force simulator 52 provides a simulated braking force to the brake pedal 46 via the master cylinder 36 as appreciated by those skilled in the art. Those skilled in the art also appreciate that the pedal force simulator 52 may be referred to as a “brake pedal feel simulator”.

The braking control module 18 may also include at least one pressure sensor 54. Each pressure sensor 54 is in fluidic communication one of the fluid lines 22 for sensing pressure in the fluid line 22. The at least one pressure sensor 54 is also in communication with the processor 34. As such, the processor 34 receives data related to the pressure at various locations in the fluid lines 22.

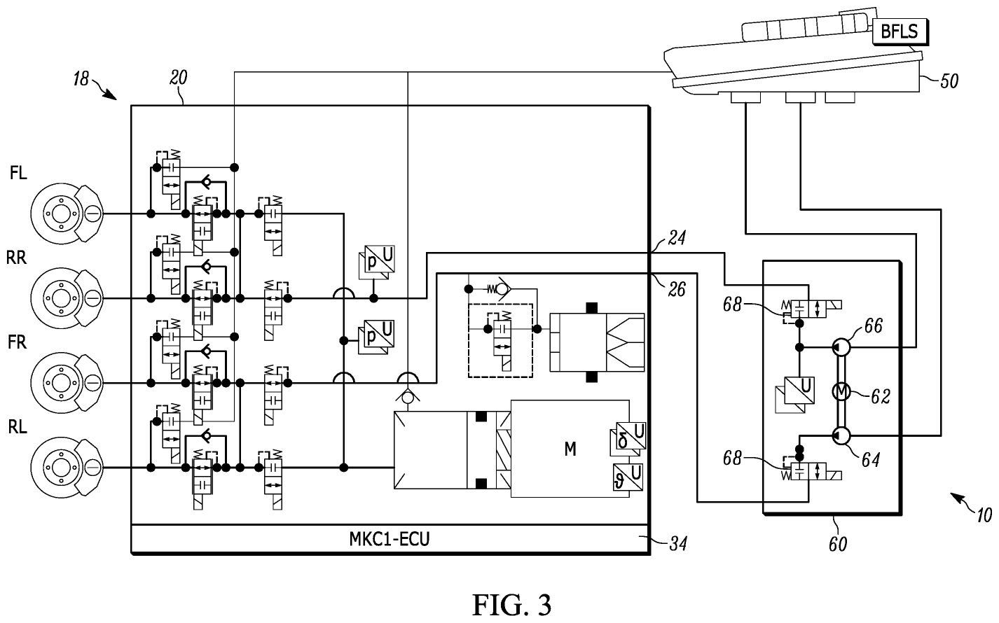

As shown in FIGS. 3 and 4, some exemplary embodiments of the braking system 10 may include an electric braking system (“EBS”) unit 60. The EBS unit 60 is disposed external from the housing 20 of the braking control module 18. In the embodiment shown in FIG. 3, the EBS unit 60 is disposed between the fluid reservoir 50 and the first and second inlet ports 24, 26 of the braking control module 18. In the embodiment shown in FIG. 4, where a tandem master cylinder 36 is utilized, the EBS unit 60 is in fluidic communication between the tandem master cylinder 36 and the first and second inlet ports 24, 26 of the braking control module 18. In FIG. 3 the EBS unit 60 and EBS unit 20 are controlled via electronic input, i.e electronic master cylinder or other electronic input method.

The EBS unit 60 includes a motor 62. The motor 62 is operatively connected to a first pump 64 and a second pump 66 for operating the pumps to pump hydraulic fluid there through. The first pump 64 is in fluidic communication with the first bore 38 and the second pump 66 is in fluidic communication with the second bore 40. In the exemplary embodiment shown in FIG. 2, the first pump 64 is also in fluidic communication with the second inlet 26 while the second pump 66 is in also in fluidic communication with the first inlet 24. Of course, the various fluidic connections for the pumps 64, 66 may be reversed or otherwise altered as appreciated by those skilled in the art. The EBS unit 60 may further include valves 68 to regulate flow of hydraulic fluid.

The EBS unit 60 may be in communication with the processor 34. As such, the processor 34 may control operation of the motor 62 and, accordingly, the first and second pumps 64, 66. The processor 34 may also control operation of the valves 68.

The EBS unit 60 allows for hydraulic pressure to be applied to all four brakes 16, even in the event of a failure of the actuator 28 disposed in the housing 20 of the braking control module 18. As such, the EBS unit 60 allows for redundant operation of the brakes 16 in the event of a failure to the actuator 28, as is generally required in autonomous vehicle 12 operation.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A braking system for a vehicle comprising:
a braking control module comprising:
a housing,
at least one fluid line disposed within said housing,
a first inlet port in communication with said at least one fluid line,
a linear actuator in fluidic communication with said at least one fluid line for controlling pressure in said at least one fluid line,
a processor in communication with said linear actuator for controlling operation of said linear actuator, and
at least one outlet port in fluidic communication with said at least one fluid line and connectable to a brake; and
an electric braking system (“EBS”) unit in fluidic communication with the first and second inlet ports of the braking control module, said EBS unit comprising:
a motor,
a first pump operatively connected to said motor and in fluidic communication with said first bore, and
a second pump operatively connected to said motor and in fluidic communication with said second bore.

2. The braking system as set forth in claim 1, further comprising a second inlet port in fluidic communication with said at least one fluid line and a tandem master cylinder comprising:
a first bore defining a first volume;
a second bore defining a second volume;
a first piston operatively connectable to a brake pedal and in fluidic connection with said first inlet port; and
a second piston operatively connectable to the brake pedal and in fluidic connection with said second inlet port.

3. The braking system as set forth in claim 2, wherein the second volume is different from the first volume.

4. The braking system as set forth in claim 2, further comprising a variable ratio mechanism operatively connected to the tandem master cylinder to provide a variable pedal ratio between the brake pedal and the tandem master cylinder.

5. The braking system as set forth in claim 2, further comprising a fluid reservoir in fluidic communication with said first bore and said second bore of said tandem master cylinder.

6. The braking system as set forth in claim 1, further comprising a single master cylinder comprising:
a first bore defining a first volume; and
a first piston operatively connectable to a brake pedal and in fluidic connection with said first inlet port.

7. The braking system as set forth in claim 1, further comprising an electronic master cylinder comprising an electronic input to the braking control module.

8. The braking system as set forth in claim 1, further comprising a fluid reservoir in fluidic communication with said first bore and said second bore of said EBS unit.

9. The braking system as set forth in claim 1, wherein said braking control module further comprises at least one pressure sensor in communication with said processor and configured to sense pressure in said at least one fluid line.

10. The braking system as set forth in claim 1, further comprising at least one travel sensor configured to determine a distance travelled by at least one of said first piston and said second piston.

11. The braking system as set forth in claim 1, wherein said braking control module further comprises a pedal force simulator in fluidic communication with said at least one fluid line.

12. A braking system for a vehicle comprising:
a braking control module comprising:
a housing,
at least one fluid line disposed within said housing,
a first inlet port in fluidic communication with said at least one fluid line;
a second inlet port in fluidic communication with said at least one fluid line,
a linear actuator in fluidic communication with said at least one fluid line for controlling pressure in said at least one fluid line,
a processor in communication with said linear actuator for controlling operation of said linear actuator, and
at least one outlet port in fluidic communication with said at least one fluid line and connectable to a brake; and
a tandem master cylinder comprising:
a first bore defining a first volume,
a second bore defining a second volume,
a first piston operatively connectable to a brake pedal and in fluidic connection with said first inlet port, and
a second piston operatively connectable to the brake pedal and in fluidic connection with said second inlet port.

13. The braking system as set forth in claim 12, wherein the second volume is different from the first volume.

14. The braking system as set forth in claim 12, further comprising a variable ratio mechanism operatively connected to the tandem master cylinder to provide a variable pedal ratio between the brake pedal and the tandem master cylinder.

15. The braking system as set forth in claim 12, further comprising an electric braking system (“EBS”) unit in fluidic communication between the tandem master cylinder and the first and second inlet ports of the braking control module, said EBS unit comprising:
a motor;
a first pump operatively connected to said motor and in fluidic communication with said first bore; and
a second pump operatively connected to said motor and in fluidic communication with said second bore.

16. The braking system as set forth in claim 15, further comprising a fluid reservoir in fluidic communication with said first bore and said second bore of one of said tandem master cylinder and said EBS unit.

17. The braking system as set forth in claim 12, wherein said braking control module further comprises at least one pressure sensor in communication with said processor and configured to sense pressure in said at least one fluid line.

18. The braking system as set forth in claim 12, further comprising at least one travel sensor configured to determine a distance travelled by at least one of said first piston and said second piston.

19. The braking system as set forth in claim 12, wherein said braking control module further comprises a pedal force simulator in fluidic communication with said at least one fluid line.
